(19) United States
(12) Patent Application Publication
(10) Pub. No.: US 2022/0237624 A1
(43) Pub. Date: Jul. 28, 2022

(54) INFORMATION PROCESSING DEVICE, INFORMATION PROCESSING METHOD, AND NON-TRANSIENT COMPUTER- READABLE STORAGE MEDIUM STORING PROGRAM

(71) Applicant: TOYOTA JIDOSHA KABUSHIKI KAISHA, Toyota-shi (JP)

(72) Inventors: Jun HIOKI, Nagakute-shi (JP); Hideo HASEGAWA, Nagoya-shi (JP); Shintaro OSAKI, Handa-shi (JP); Hiroaki SASAKI, Nagoya-shi (JP); Yoshihiro UI, Nagoya-shi (JP)

(73) Assignee: TOYOTA JIDOSHA KABUSHIKI KAISHA, Toyota-shi (JP)

(21) Appl. No.: 17/573,704

(22) Filed: Jan. 12, 2022

(30) Foreign Application Priority Data
Jan. 25, 2021 (JP) 2021-009844

(51) Int. Cl. G06Q 30/00; G10L 25/78; G10L 25/72; G10L 21/16

(52) U.S. Cl. CPC G06Q 30/01; G10L 21/16; G10L 25/72; G10L 25/78

(57) ABSTRACT

An information processing device includes a processor, the processor being configured to: acquire sound data collected in a predetermined facility; extract voice data generated by speech of a person in the predetermined facility from the sound data; and evaluate a status of customers in the predetermined facility based on the voice data.

### CROSS-REFERENCE TO RELATED APPLICATION

This application claims priority to Japanese Patent Application No. 2021-009844 filed on Jan. 25, 2021, incorporated herein by reference in its entirety.

### BACKGROUND

### 1. Technical Field

The present disclosure relates to a technique for grasping the status of customers in a facility.

### 2. Description of Related Art

WO 2018/168119 discloses a technique related to an information processing device that identifies and outputs the status of a store. In the technique disclosed in WO 2018/168119, the information processing device acquires voice data generated by a microphone installed in the store as store raw information. The information processing device identifies the degree of noisiness of the store based on the acquired voice data. The information processing device also outputs the identified degree of noisiness of the store as the status of the store.

### SUMMARY

It is an object of the present disclosure to make it possible to grasp the status of customers in a predetermined facility.

An aspect of the present disclosure relates to an information processing device including a processor, the processor being configured to: acquire sound data collected in a predetermined facility; extract voice data generated by speech of a person in the predetermined facility from the sound data; and evaluate a status of customers in the predetermined facility based on the voice data.

An aspect of the present disclosure relates to an information processing method that is performed by a computer, the information processing method comprising: acquiring sound data collected in a predetermined facility; extracting voice data generated by speech of a person in the predetermined facility from the sound data; and evaluating a status of customers in the predetermined facility based on the voice data.

An aspect of the present disclosure relates to a non-transient computer-readable storage medium storing a program, the program, when executed by a processor, causing the processor to: acquire sound data collected in a predetermined facility; extract voice data generated by speech of a person in the predetermined facility from the sound data; and evaluate a status of customers in the predetermined facility based on the voice data.

According to the present disclosure, it is possible to grasp the status of customers in a predetermined facility.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a schematic configuration of an information provision system;

FIG. 2 is a block diagram schematically showing an example of functional configurations of a management server and a user terminal according to a first embodiment;

FIG. 3 shows an example of a table configuration of store information;

FIG. 4 is a flowchart illustrating the flow of information processing according to the first embodiment;

FIG. 5 is a block diagram schematically showing an example of a functional configuration of a management server according to a second embodiment;

FIG. 6 is a block diagram schematically showing an example of a functional configuration of a management server according to a modification of the second embodiment;

FIG. 7 shows an example of a table configuration of store information stored in a store information database;

FIG. 8 is a block diagram schematically showing an example of a functional configuration of a management server according to a third embodiment;

FIG. 9 shows an example of how the user terminal outputs synthesized data on a designated store; and

FIG. 10 is a flowchart illustrating the flow of information processing according to the third embodiment.

### DETAILED DESCRIPTION OF EMBODIMENTS

An information processing device according to the present disclosure includes a control unit. The control unit acquires sound data collected in a predetermined facility. The predetermined facility may be a facility that the user is considering to use. The sound data is collected by a microphone etc. installed in the predetermined facility. The sound data collected in the predetermined facility includes voice data generated by speech of a person(s) present in the predetermined facility (hereinafter sometimes simply referred to as the “voice data”). However, the sound data also includes data regarding sound other than the voice data (hereinafter sometimes referred to as the “background noise data”). For example, the background noise data is data of sound generated by work in the predetermined facility or sound coming into the predetermined facility from the outside.

The control unit extracts the voice data from the acquired sound data. The control unit then evaluates the status of customers in the predetermined facility based on the extracted voice data.

As described above, the voice data extracted by the control unit is data regarding the voice generated by speech of a person(s) present in the predetermined facility (that is, a customer(s) present in the predetermined facility). Accordingly, the voice data has a higher correlation with the status of customers in the predetermined facility than the sound data collected in the predetermined facility does. For example, it is therefore possible to evaluate the degree of noisiness due to the speech of the person(s) present in the predetermined facility according to the voice data. It is also possible to evaluate the customer classification in the predetermined facility according to the voice data.

Image data obtained by capturing an image of the inside of the predetermined facility may be used to evaluate the status of customers in the predetermined facility. However, it is not preferable to capture an image of the inside of the predetermined facility for the privacy of customers present in the predetermined facility. Since the voice data is used in the present embodiment, the status of customers in the predetermined facility can be evaluated without using image data obtained by capturing an image of the inside of the predetermined facility. It is therefore possible to protect the privacy of customers present in the store.

According to the present disclosure, it is possible to grasp the status of customers in the predetermined facility.

Hereinafter, specific embodiments of the present disclosure will be described with reference to the drawings. The dimensions, materials, shapes, relative arrangements, etc. of components described in the embodiments are not intended to limit the technical scope of the present disclosure to those dimensions, materials, shapes, relative arrangements, etc. unless otherwise specified.

### First Embodiment

### System Overview

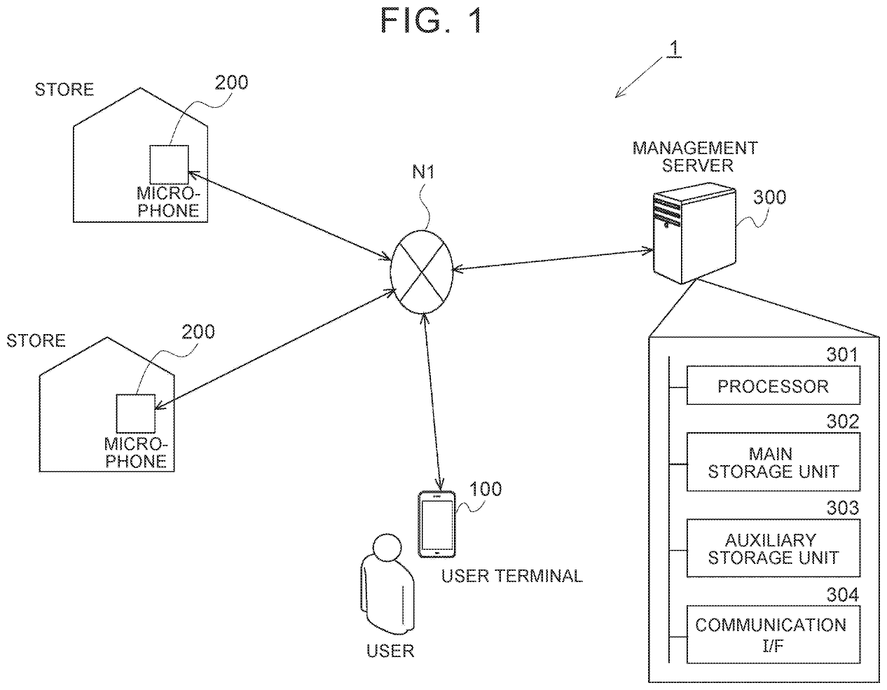

FIG. 1 shows a schematic configuration of an information provision system according to the present embodiment. The information provision system is a system that provides a user with the status of customers in a store. The information provision system 1 includes a user terminal 100, a management server 300, and microphones 200 installed in a plurality of stores. In this example, the stores where the microphone 200 is installed are restaurants.

In the information provision system 1, the user terminal 100, the management server 300, and each microphone 200 are connected to each other via a network N1. For example, the network N1 may be a wide area network (WAN) that is a world-wide public communication network such as the Internet, or a telephone communication network for mobile phones etc.

Each microphone 200 collects sound in the store. The microphone 200 can send the collected sound data to the management server 300 via the network N1. The user terminal 100 is a terminal carried or operated by the user. For example, the user terminal 100 can be a smartphone, a tablet computer, or a wearable terminal. The user terminal 100 can send designation information indicating the store designated by the user to the management server 300 via the network N1. In the following description, the store designated by the user is sometimes referred to as the “designated store.”

The management server 300 is a server device that evaluates the status of customers in a store and provides the user with the evaluation results. The management server 300 includes a commonly used computer. The computer of the management server 300 includes a processor 301, a main storage unit 302, an auxiliary storage unit 303, and a communication interface (communication I/F) 304.

The processor 301 is, for example, a central processing unit (CPU) or a digital signal processor (DSP). The main storage unit 302 is, for example, a random access memory (RAM). The auxiliary storage unit 303 is, for example, a read-only memory (ROM), a hard disk drive (HDD), or a flash memory. The auxiliary storage unit 303 may include a removable medium (portable recording medium). The removable medium is, for example, a universal serial bus (USB) memory, a secure digital (SD) card, or a disc recording medium such as compact disc read-only memory (CD-ROM), digital versatile disc (DVD), or Blu-ray disc. The communication I/F 304 is, for example, a local area network (LAN) interface board or a wireless communication circuit for wireless communication.

The auxiliary storage unit 303 stores an operating system (OS), various programs, various information tables, etc. The processor 301 loads the programs stored in the auxiliary storage unit 303 into the main storage unit 302 and executes the programs. The processor 301 thus implements control for evaluating the status of customers in the store and control for providing the user with the evaluation results. Part or all of the functions of the management server 300 may be implemented by a hardware circuit such as application-specific integrated circuit (ASIC) or field-programmable gate array (FPGA). The management server 300 need not necessarily be implemented by a single physical configuration, and may be configured by a plurality of computers that cooperates with each other. In the present embodiment, the management server 300 corresponds to the “information processing device” according to the present disclosure.

The management server 300 receives sound data from the microphone 200 installed in the designated store. The management server 300 then evaluates the status of customers in the designated store based on the received sound data. A method for evaluating the status of customers that is performed by the management server 300 will be described in detail later.

The management server 300 sends the status of customers in the designated store obtained as the evaluation results to the user terminal 100 via the network N1 as store information. The user terminal 100 outputs the store information received from the management server 300. The user can thus grasp the status of customers in the store designated by himself or herself.

### Functional Configurations

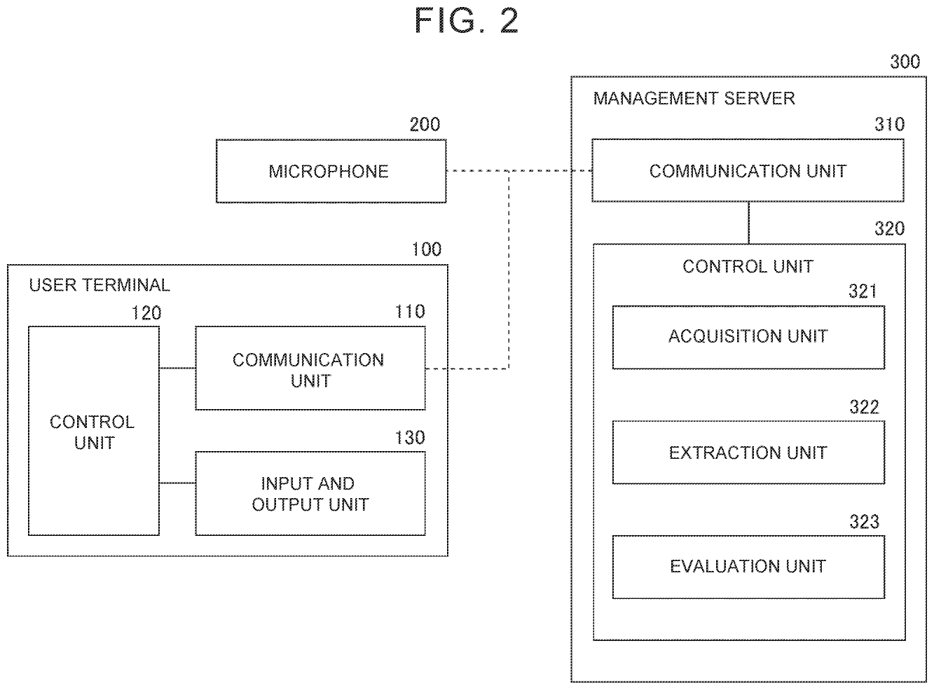

Next, the functional configurations of the management server 300 and the user terminal 100 of the information provision system 1 will be described with reference to FIG. 2. FIG. 2 is a block diagram schematically showing an example of the functional configurations of the management server 300 and the user terminal 100 according to the present embodiment.

### Management Server

The management server 300 has a communication unit 310 and a control unit 320. The communication unit 310 has a function to connect the management server 300 to the network N1. The communication unit 310 can be implemented by the communication I/F 304. The control unit 320 has a function to perform arithmetic calculations for controlling the management server 300. The control unit 320 can be implemented by the processor 301.

The control unit 320 performs a process of receiving via the communication unit 310 designated information sent from the user terminal 100. The designated information includes a store identification (ID) that is identification information identifying the designated store. The control unit 320 also performs a process of sending via the communication unit 310 request information to the microphone 200 installed in the designated store indicated by the designated information received from the user terminal 100. The request information is information requesting transmission of sound data collected by the microphone 200 in the designated store. The control unit 320 also performs a process of receiving via the communication unit 310 the sound data sent from the microphone 200 that has received the request information. The management server 300 can thus receive the sound data collected by the microphone 200 installed in the designated store.

The control unit 320 includes an acquisition unit 321, an extraction unit 322, and an evaluation unit 323 as functional units. The acquisition unit 321 acquires the sound data of the designated store received via the communication unit 310 from the microphone 200. The sound data of the designated store includes voice data generated by speech of a person(s) present in the designated store and background noise data.

The extraction unit 322 performs an extraction process in order to extract the voice data from the sound data of the designated store acquired by the acquisition unit 321. In the extraction process, any known method may be used as a method for extracting the voice data from the sound data. For example, the extraction process may be a process of extracting the voice data by separating the sound data into the voice data and the background noise data. The extraction process may alternatively be a process of extracting the voice data by deleting the background noise data from the sound data.

The evaluation unit 323 then performs an evaluation process for evaluating the status of customers in the designated store, based on the voice data of the designated store extracted by the extraction unit 322. Specifically, the evaluation unit 323 evaluates the degree of noisiness due to the speech of the person(s) present in the designated store (hereinafter sometimes simply referred to as the “degree of noisiness”) and the classification of customers in the designated store (hereinafter sometimes simply referred to as the “customer classification”). The degree of noisiness can be represented by, for example, the level of loudness of the sound. The degree of noisiness can be evaluated based on the loudness of the sound of the voice data etc. The customer classification can be represented by, for example, the male to female ratio of the people (customers) present in the designated store or the male to female ratio for each age group. The customer classification can be evaluated by estimating the gender and age of each individual based on the individual's voice included in the voice data.

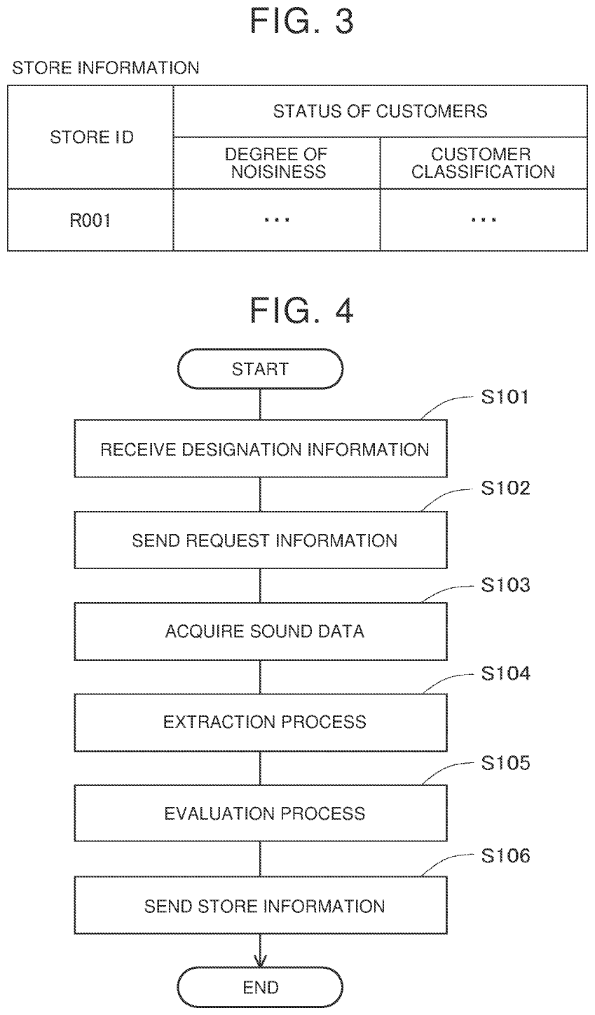

The control unit 320 generates store information on the designated store based on the evaluation results obtained by the evaluation unit 323. FIG. 3 shows an example of a table configuration of the store information. As shown in FIG. 3, the store information has a store ID field and a customer status field. The store ID of the designated store is input to the store ID field. The degree of noisiness and customer classification evaluated by the evaluation unit 323 are input to the customer status field. The control unit 320 also performs a process of sending the generated store information on the designated store to the user terminal 100 via the communication unit 310.

### User Terminal

The user terminal 100 has a communication unit 110, a control unit 120, and an input and output unit 130. The communication unit 110 has a function to connect the user terminal 100 to the network N1. The communication unit 110 can be implemented by a communication interface included in the user terminal 100. The communication unit 110 can communicate with other devices including the management server 300 via the network N1 by using a mobile communication service such as 3rd Generation (3G) or Long Term Evolution (LTE).

The control unit 120 has a function to perform arithmetic calculations for controlling the user terminal 100. The control unit 120 can be implemented by a processor included in the user terminal 100. The input and output unit 130 has a function to receive an input operation performed by the user and a function to output information to be presented to the user. For example, the input and output unit 130 includes a touch panel display and a speaker.

When the user designates a store via the input and output unit 130, the control unit 120 generates designation information indicating the designated store. The user may designate a store on a map displayed on the touch panel display included in the input and output unit 130. The control unit 120 then performs a process of sending the generated designation information to the management server 300 via the communication unit 110. The control unit 120 also performs a process of receiving via the communication unit 110 the store information on the designated store sent from the management server 300.

When the control unit 120 receives the store information from the management server 300, the control unit 120 outputs the received store information via the input and output unit 130. The user can thus grasp the degree of noisiness and the customer classification as the status of customers in the designated store.

### Information Processing

Next, the flow of information processing that is performed by the management server 300 in order to provide the user with the status of customers in the designated store will be described with reference to FIG. 4. FIG. 4 is a flowchart illustrating the flow of the information processing according to the present embodiment. This flow is executed by the control unit 320 of the management server 300.

In this flow, in S101, the control unit 320 first receives designation information sent from the user terminal 100. Next, in S102, the control unit 320 sends request information to the microphone 200 installed in the designated store. At this time, the control unit 320 identifies the designated store based on the designation information received in S101. Thereafter, in S103, the control unit 320 acquires sound data of the designated store received from the microphone 200 installed in the designated store.

Next, the control unit 320 performs the extraction process in S104. The control unit 320 thus extracts voice data from the sound data of the designated store acquired in S103. Next, the control unit 320 performs the evaluation process in S105. The control unit 320 thus evaluates the degree of noisiness and customer classification in the designated store based on the voice data extracted in S104. When the control unit 320 performs the evaluation process in S105, the control unit 320 generates store information on the designated store based on the evaluation results. Subsequently, in S106, the control unit 320 sends the store information on the designated store to the user terminal 100. As a result, the user terminal 100 outputs the store information on the designated store.

As described above, in the information provision system 1, the status of customers in the designated store is evaluated using voice data instead of image data. It is therefore not necessary to capture images including a customer(s) at each store. Accordingly, it is possible to protect the privacy of customers present in the store. It is also possible to reduce the capacity of data that is sent from the store to the management server 300 as compared to the case where image data is sent from the store to the management server 300.

The voice data generated by speech of a person(s) present in the designated store has a higher correlation with the status of customers in the designated store than the sound data collected by the microphone 200 does. It is therefore possible to evaluate the degree of noisiness due to speech of a person(s) in the designated store and the customer classification in the designated store based on the voice data, as described above.

In the present embodiment, the management server 300 acquires the sound data of the designated store and evaluates the status of customers in the designated store at the time the management server 300 receives the designation information from the user terminal 100. The user can thus grasp the status of customers in real time at the time he or she designates a store on the user terminal 100.

### Second Embodiment

The schematic configuration of an information provision system according to the present embodiment is similar to that of the first embodiment. In the present embodiment, however, the functional configuration of the management server 300 is partially different from that of the first embodiment.

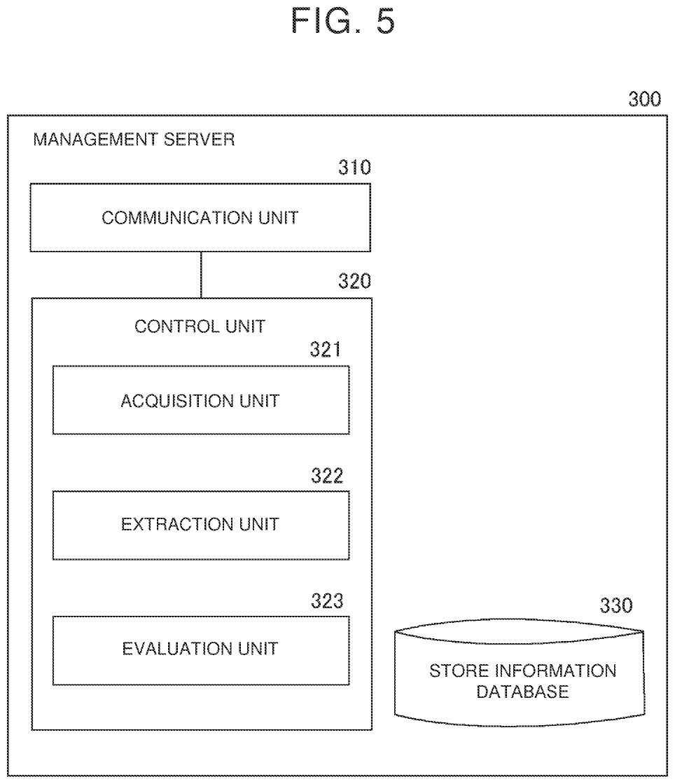

FIG. 5 is a block diagram schematically showing an example of the functional configuration of the management server 300 according to the present embodiment. As shown in FIG. 5, in the present embodiment, the management server 300 has a store information database (store information DB) 330 in addition to the communication unit 310 and the control unit 320.

In the present embodiment, the management server 300 periodically receives sound data from the microphones 200 installed in each store. The control unit 320 performs the extraction process and the evaluation process based on the sound data of each store received periodically. The extraction and evaluation processes that are performed at this time are similar to those in the first embodiment. Accordingly, the degree of noisiness due to speech of a person(s) present in each store and the customer classification in each store are evaluated based on the voice data extracted from the sound data of each store.

The control unit 320 generates store information on each store based on the evaluation results in the evaluation process. The generated store information on each store is stored in the store information DB 330. The store information DB 330 can be implemented by the auxiliary storage unit 303 in the management server 300. In the present embodiment, the store information DB 330 corresponds to the “storage unit” according to the present disclosure.

In the management server 300, the extraction process and the evaluation process are performed based on the sound data received periodically from the microphones 200 installed in each store. The status of customers in each store can therefore be evaluated for each time period. The store information DB 330 stores the status of customers in each time period in each store as store information.

When the control unit 320 receives designation information from the user terminal 100, the control unit 320 acquires the store information on the designated store from the store information DB 330. The control unit 320 sends the acquired store information on the designated store to the user terminal 100. At this time, the control unit 320 sends the store information indicating the status of customers in each time period in the designated store to the user terminal 100. The user can thus grasp the status of customers in each time period in the designated store.

### Modification

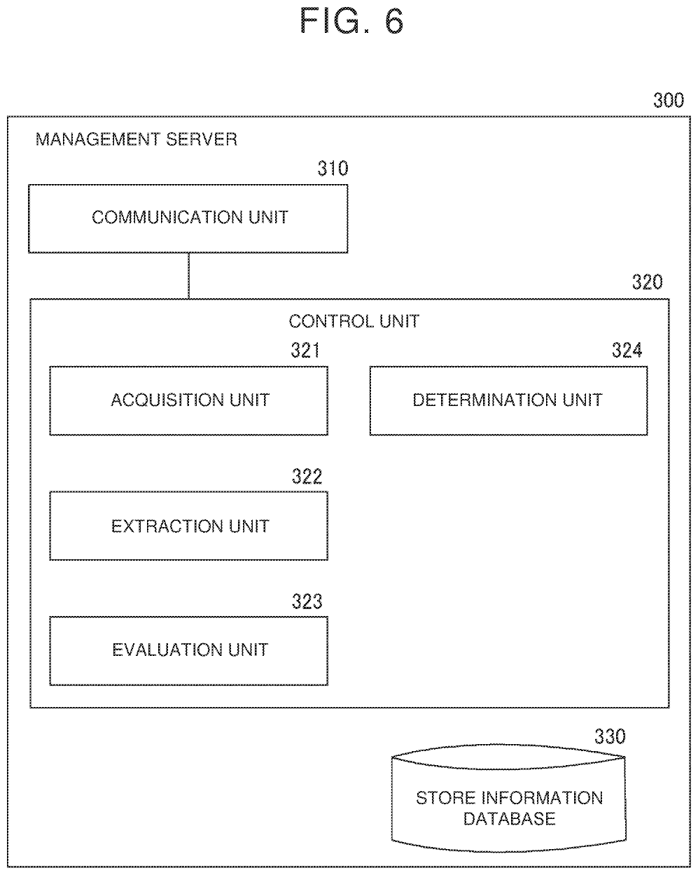

Next, a modification of the present embodiment will be described. FIG. 6 is a block diagram schematically showing an example of the functional configuration of the management server 300 according to this modification. As shown in FIG. 6, in this modification, the management server 300 has the communication unit 310, the control unit 320, and the store information DB 330. The control unit 320 includes a determination unit 324 as a functional unit in addition to the acquisition unit 321, the extraction unit 322, and the evaluation unit 323.

The determination unit 324 performs a determination process for determining an attribute regarding the atmosphere of each store (hereinafter sometimes simply referred to as the “attribute”). The attribute of the store may be defined as, for example, the situation suitable for using the store. Examples of the situation that can be defined as the attribute of the store include “dating,” “business meal,” “meal with friends,” “large group party,” and “meal with children.” The determination unit 324 determines the attribute of each store based on the evaluation results of the status of customers in each store. That is, the determination unit 324 can determine the attribute of each store based on the degree of noisiness due to speech of a person(s) present in each store and the customer classification in each store.

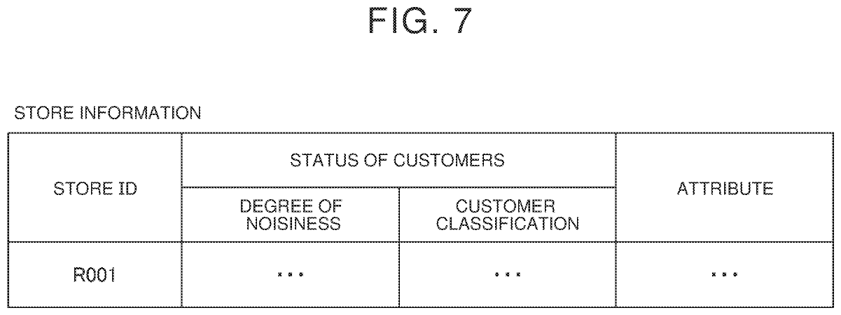

The control unit 320 stores the attribute of each store as well as the status of customers in each store in the store information DB 330 as store information. FIG. 7 shows an example of a table configuration of the store information stored in the store information DB 330. As shown in FIG. 7, the store information has an attribute field in addition to the store ID field and the customer status field. The attribute determined by the determination unit 324 is input to the attribute field.

In this modification, the user can designate the attribute of a store on the user terminal 100 instead of designating a specific store. When the user designates the attribute of a store via the input and output unit 130, designation information indicating the designated attribute is sent from the user terminal 100 to the management server 300.

When the management server 300 receives the designation information from the user terminal 100, the control unit 320 acquires store information on a store having an attribute matching the attribute indicated by the designation information from the store information DB 330. The control unit 320 sends the acquired store information to the user terminal 100. The user can thus find out the store having an attribute matching the desired attribute and grasp the status of customers in that store.

### Third Embodiment

The schematic configuration of an information provision system according to the present embodiment is similar to that of the first embodiment. In the present embodiment, however, the functional configuration of the management server 300 is partially different from that of the first embodiment.

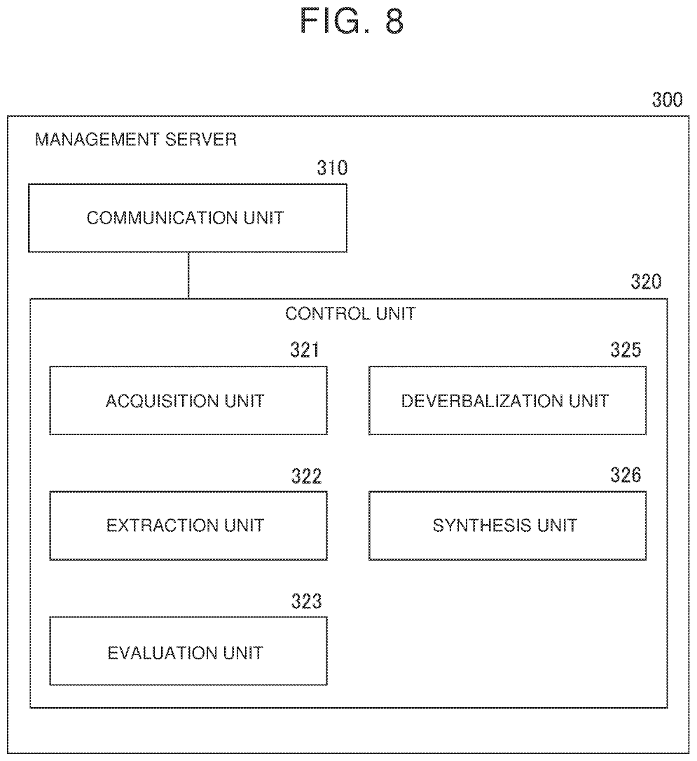

FIG. 8 is a block diagram schematically showing an example of the functional configuration of the management server 300 according to the present embodiment. As shown in FIG. 8, in the present embodiment, the management server 300 has the communication unit 310 and the control unit 320. The control unit 320 includes a deverbalization unit 325 and a synthesis unit 326 as functional units in addition to the acquisition unit 321, the extraction unit 322, and the evaluation unit 323.

In the management server 300, the extraction unit 322 performs the extraction process. The extraction unit 322 thus extracts voice data from the sound data of the designated store acquired by the acquisition unit 321. In this case, the extraction process is a process of separating the sound data into voice data and background noise data. The evaluation unit 323 performs the evaluation process based on the voice data of the designated store extracted by the extraction unit 322.

The deverbalization unit 325 performs a deverbalization process on the voice data of the designated store. As described above, the voice data is data on the voice generated by speech of a person(s) present in the designated store. Accordingly, the voice data is language data generated by the person(s) present in the designated store. The deverbalization process is a process of deverbalizing this voice data while maintaining the characteristics of the sound. That is, the deverbalization process is a process of converting voice data to sound data different from language data while maintaining the loudness, intervals, and timbre of the original voice data. When the voice data subjected to the deverbalization process is output, sound data having characteristics similar to those of sound that the original voice data has is output in a form in which the content of speech of the person(s) included in the original voice data cannot be heard. The deverbalization process may be implemented by any known method. In the present embodiment, the deverbalization process corresponds to the “predetermined process” according to the present disclosure.

The synthesis unit 326 performs a synthesis process for synthesizing the background noise data included in the sound data of the designated store and the voice data subjected to the deverbalization process. In the synthesis process, any known method may be used as a method for synthesizing the background noise data and the voice data subjected to the deverbalization process. Synthetized data generated in the synthesis process by the synthesis unit 326 is sent from the management server 300 to the user terminal 100 together with the store information of the designated store.

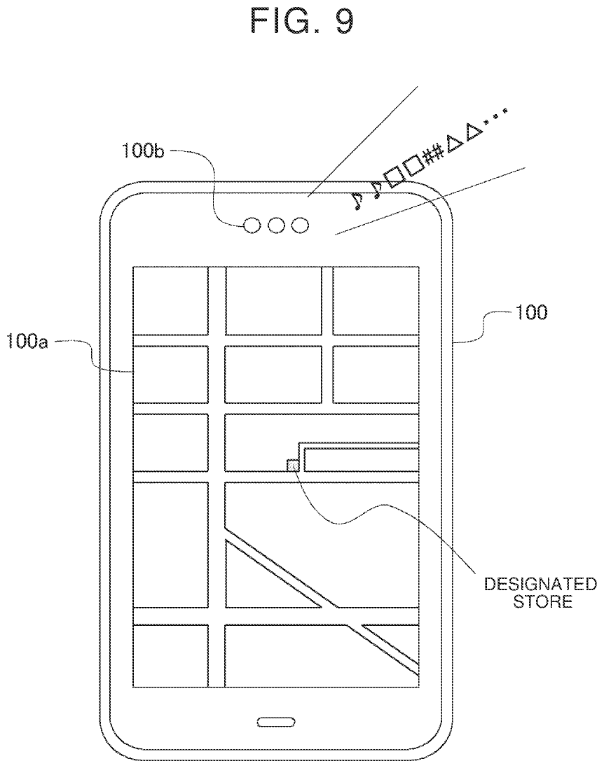

When the user terminal 100 receives the synthesized data together with the store information from the management server 300, the control unit 120 outputs the store information and the synthesized data using the input and output unit 130. FIG. 9 shows an example of how the user terminal 100 outputs the synthesized data on the designated store. In FIG. 9, a map including a store designated by the user is displayed on a touch panel display 100a included in the input and output unit 130 of the user terminal 100. In this case, with the map including the designated store being displayed on the touch panel display 100a, the synthesized data on the designated store is output from a speaker 100b included in the input and output unit 130. At this time, the store information on the designated store may be displayed superimposed on the map on the touch panel display 100a.

As the user terminal 100 outputs the synthesized data on the designated store in addition to the store information, the user can grasp the status of the designated store as sound. The user can thus determine the status of customers in the designated store using his or her own sense. The user cannot hear the content of speech of the person(s) included in the original voice data from the synthesized data. It is therefore possible to protect the privacy of customers present in the store.

### Information Processing

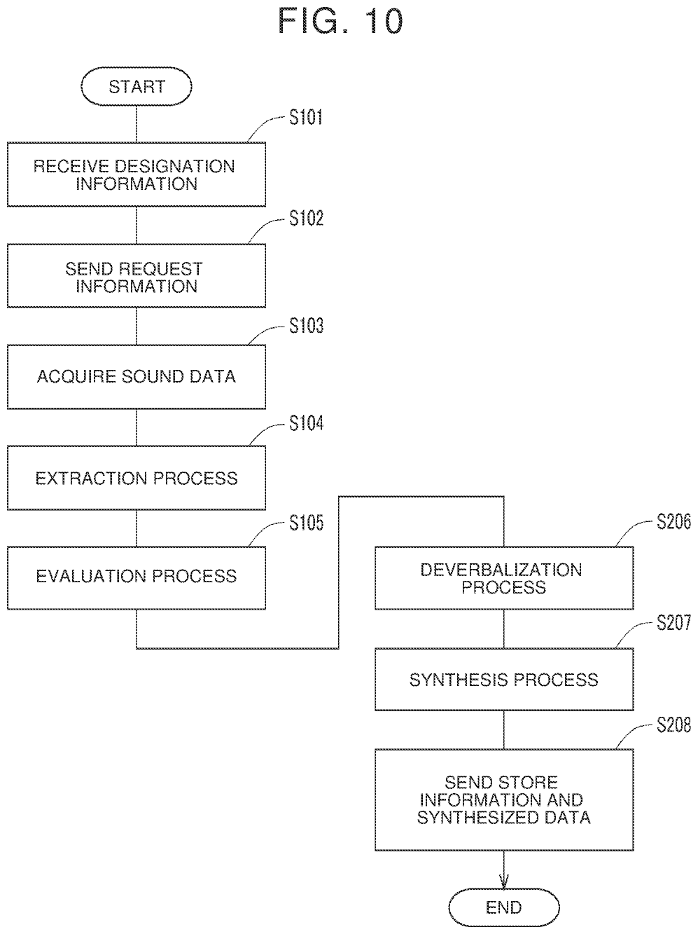

Next, the flow of information processing that is performed by the management server 300 in order to provide the user with the status of customers in the designated store and the synthetized data will be described with reference to FIG. 10. FIG. 10 is a flowchart illustrating the flow of the information processing according to the present embodiment. This flow is executed by the control unit 320 of the management server 300. The processes that are performed in S101 to S105 in this flow are similar to the processes that are performed in S101 to S105 in the flow shown in FIG. 4. Accordingly, description of these steps will be omitted.

In this flow, S206 is performed after S105. In S206, the control unit 320 performs the deverbalization process on the voice data extracted in S104. Next, the control unit 320 performs the synthesis process in S207. The voice data subjected to the deverbalization process in S206 and background noise data of the designated store are thus synthesized to produce synthesized data. The control unit 320 may perform the evaluation process in S105 and the processes in S206 and S207 in parallel. Subsequently, in S208, the control unit 320 sends store information on the designated store and the synthesized data to the user terminal 100. As a result, the user terminal 100 outputs the store information on the designated store and the synthesized data.

In the first to third embodiments, the store that is a restaurant corresponds to the “predetermined facility” according to the present disclosure. However, the “predetermined facility” according to the present disclosure is not limited to restaurants. For example, the information provision system according to the first to third embodiments can be applied to a system for providing the user with the status of customers in a shared office. According to such an information provision system, the user can grasp the status of use of the office by other users. The information provision system according to the first to third embodiments can also be applied to a system for evaluating the status of customers in a facility other than a restaurant or a shared office that the user is considering to use and providing the user with the evaluation results.

### OTHER EMBODIMENTS

The above embodiments are by way of example only, and the present disclosure may be modified as appropriate without departing from the spirit and scope of the present disclosure. For example, the processes and means described in the present disclosure can be combined as desired as long as no technical contradiction occurs.

The processes described as being performed by one device may be allocated to and performed by a plurality of devices. Alternatively, the processes described as being performed by different devices may be performed by one device. The type of hardware configuration (server configuration) that is used to implement each function in the computer system can be flexibly changed.

The present disclosure can also be implemented by supplying computer programs implementing the functions described in the above embodiments to a computer, and causing one or more processors of the computer to read and execute the programs. Such computer programs may be provided to the computer by a non-transitory computer-readable storage medium that can be connected to a system bus of the computer, or may be provided to the computer via a network. Examples of the non-transitory computer-readable storage medium include: any type of disk or disc such as magnetic disk (floppy (registered trademark) disk, hard disk drive (HDD), etc.), or optical disc (CD-ROM, DVD, Blu-ray disc, etc.); and any type of medium suitable for storing electronic instructions such as read-only memory (ROM), random access memory (RAM), erasable programmable read-only memory (EPROM), electrically erasable programmable read-only memory (EEPROM), magnetic card, flash memory, or optical card.

What is claimed is:

1. An information processing device comprising a processor, the processor being configured to:
acquire sound data collected in a predetermined facility;
extract voice data generated by speech of a person in the predetermined facility from the sound data; and
evaluate a status of customers in the predetermined facility based on the voice data.

2. The information processing device according to claim 1, wherein the status of customers includes a degree of noisiness due to the speech of the person in the predetermined facility.

3. The information processing device according to claim 1, wherein the status of customers includes a customer classification in the predetermined facility.

4. The information processing device according to claim 1, wherein the processor is further configured to determine an attribute regarding an atmosphere of the predetermined facility based on an evaluation result of the status of customers.

5. The information processing device according to claim 1, wherein
the predetermined facility is a facility designated by a user, and
the processor is further configured to send the status of customers to a user terminal associated with the user.

6. The information processing device according to claim 5, further comprising a memory that stores the status of customers in each time period in the predetermined facility evaluated based on the voice data, wherein the processor sends the status of customers in each time period in the predetermined facility stored in the memory to the user terminal.

7. The information processing device according to claim 5, wherein the processor is further configured to:
perform a predetermined process of deverbalizing the voice data while maintaining characteristics of sound;
synthesize the sound data excluding the voice data and the voice data subjected to the predetermined process; and
send the synthesized data to the user terminal.

8. The information processing device according to claim 7, wherein
the predetermined facility is a facility designated by the user on a map displayed on the user terminal, and
the user terminal outputs the synthesized data on the predetermined facility received from the information processing device, the synthesized data being output with the map being displayed.

9. The information processing device according to claim 1, wherein the predetermined facility is a restaurant.

10. The information processing device according to claim 1, wherein the predetermined facility is a shared office.

11. An information processing method that is performed by a computer, the information processing method comprising:
acquiring sound data collected in a predetermined facility;
extracting voice data generated by speech of a person in the predetermined facility from the sound data; and
evaluating a status of customers in the predetermined facility based on the voice data.

12. The information processing method according to claim 11, wherein the status of customers includes a degree of noisiness due to the speech of the person in the predetermined facility.

13. The information processing method according to claim 11, wherein the status of customers includes a customer classification in the predetermined facility.

14. The information processing method according to claim 11, further comprising determining an attribute regarding an atmosphere of the predetermined facility based on an evaluation result of the status of customers.

15. The information processing method according to claim 11, further comprising sending the status of customers to a user terminal associated with a user, wherein the predetermined facility is a facility designated by the user.

16. The information processing method according to claim 15, further comprising storing in a memory the status of customers in each time period in the predetermined facility evaluated based on the voice data, wherein the status of customers in each time period in the predetermined facility stored in the memory is sent to the user terminal.

17. The information processing method according to claim 15, further comprising:
performing a predetermined process of deverbalizing the voice data while maintaining characteristics of sound;
synthesizing the sound data excluding the voice data and the voice data subjected to the predetermined process; and
sending the synthesized data to the user terminal.

18. A non-transient computer-readable storage medium storing a program, the program, when executed by a processor, causing the processor to:
acquire sound data collected in a predetermined facility;
extract voice data generated by speech of a person in the predetermined facility from the sound data; and
evaluate a status of customers in the predetermined facility based on the voice data.

19. The storage medium according to claim 18, wherein
the predetermined facility is a facility designated by a user, and
when executed by the processor, the program further causes the processor to send the status of customers to a user terminal associated with the user.

20. The storage medium according to claim 19, wherein when executed by the processor, the program further causes the processor to:
perform a predetermined process of deverbalizing the voice data while maintaining characteristics of sound;
synthesize the sound data excluding the voice data and the voice data subjected to the predetermined process; and
send the synthesized data to the user terminal.
